(19) United States
(12) Patent Application Publication
(10) Pub. No.: US 2008/0095261 A1
(43) Pub. Date: Apr. 24, 2008

(54) Radiation powered battery-free energy-burst source for wireless weather stations and home-climate systems

(76) Inventors: Mauritius H.P.M. van Putten, Cambridge, MA (US); Anton F.P. van Putten, Eindhoven (NL); Michael J.A.M. van Putten, Enschede (NL); Pascal F.A.M. van Putten, Delft (NL)

Correspondence Address: MAURICE H.P.M. VAN PUTTEN, 266 PEARL STREET A, CAMBRIDGE, MA, 02139, US

(21) Appl. No.: 11/546,416

(22) Filed: Oct. 12, 2006

(51) Int. Cl. H04L 27/00

(52) U.S. Cl. 375/295

(57) ABSTRACT

The power of a complete picture of energy-weather information can be used for novel energy saving algorithms in home-climate systems. Exploiting the human biological clock, we recently proposed to optimize climate systems by allowing for a correlation between inside and outside temperatures, while preserving maximal comfort. Following our earlier disclosure on a Gas Energy Observatory, we here disclose a detailed description of a battery-free wireless weather station for reliable, long-term and maintenance-free measurements. It is solar powered. Combined with energy storage in high-voltage capacitors using recently introduced low-cost step-up and step-down DC-DC converters, a versatile energy burst-source is created. Energies of a few J per day suffice for measurement, data-collection and wireless data transmission in bursts to a central data-processing device inside a nearby home. Provided as a high-volume consumer product, residential weather data can be gathered over the internet for creating a climate observation system with unprecedented areal coverage and spatial resolution at no additional cost—serving modern climate research and studies on global warming.

### REFERENCES

1. Gali, C. E., 1994, U.S. Pat. No. 52,763,293
2. National Academy of Sciences, 1999, “Adequacy of climate observing systems”
3. Trescases, O., & Ng, W. T., 2004, 35th IEEE Power Electronics Specialists Conference, Germany
4. van Putten, M. H. P. M., van Putten, M. J. A. M., van Putten, A. F. P., & van Putten, P. F. A. M., 2006, U.S. patent application Ser. No. 11/337,950
5. van Putten, M. H. P. M., van Putten, M. J. A. M., van Putten, A. F. P., & van Putten. P. F. A. M., 2006, U.S. patent application Ser. No. 11/495,703

### BACKGROUND OF THE INVENTION

There is currently a convergence of multiple market forces driving innovation in distributed energy computing and management systems.

The information society is continuing to develop as a powerful force towards a global economy. The information society not only covers news, but also large amounts of data from a wide variety of observational, measurement and financial sources. This development has contributed to a gradual deregulation of the energy market. In some (but not all) sectors, the energy market is free from government and/or industry-to-industry agreements. An open energy market can facilitate the creation of new energy information technology. At present, commercial (financial) energy data are practically non-existent as a consumer product. However, the adverse impact of global energy needs (met mostly by fossile fuels) on the global global climate poses a challenge to public policy to shape the right kind of market conditions for maximizing opportunities for energy saving information technologies.

High-resolution (financial) energy data in electronic format are essential to smart energy management systems. We recently showed the complete picture in residential gas-energy usage becomes apparent in high-resolution energy-weather data, revealing both detailed human behavior in using residential facilities and heating. The same data can serve as input to for novel energy-saving algorithms for home-climate control. Evidently, this is a topic for further study, but already there appears to be much room for improvements by further exploiting the human biological clock in allowing home-climate to have time-varying temperatures, e.g., by correlations to the outside local weather (van Putten et al. 2006). Energy-weather data further enable fore-casts on cost-savings and validation of home improvements. Connected to the internet, the local weather data can also create a wide-area high-resolution global climate observation system.

Gather local weather data is best pursued using a reliable and maintenance-free device outside the house, using a wireless link for data-transmission. In this disclosure, we introduce a battery-free weather station, which is environmental friendly, allowing long-term monitoring at no cost. It is made possible by a solar powered energy burst-source, comprising the following elements:
Solar cells for the source of energy
Voltage-controlled DC-DC step-up converter
A DC-DC step-down converter
Large capacitor for energy storage up to a few Joules.

Only recently have DC-DC converters reached the level of low-cost, suitable for the consumer market. For example, the recent introduction of Simple Switchers(R) by National Semiconductor Inc. is a remarkable development in low-cost devices. It promises to open up a wide range of novel commercial applications. Here, we show that this development gives a realistic prospect for battery-free wireless sensing applications, suitable for the consumer market.

### SUMMARY OF THE DISCLOSURE

The increasing distribution consumer electronics and wireless sensing brings along an increasing demand for micro-power systems. However, in some cases, remote sensors can be operated at exceptionally low duty cycles. For example, it often suffices to perform temperature measurements at intervals of 15 minutes or more. Suppose each measurement and data-storage requires 10 ms of operation time at a power level of 1 mW. The corresponding duty cycle is 10⁻⁵ and the total energy consumption is 1 J per day. This poses an interesting window of opportunity to configure power systems for such devices on the basis of total energy usage per day, rather than on the basis of instantaneous power levels. Likewise, on-off switch operations of a heating system can be pursued at very low duty-cycles. These operations are commonly performed by home-climate systems, as part of their temperature control activities. The power requirement of these actuators are, in many cases, very similar although not identical to that of a remote weather station. We shall refer to power systems for devices with low-duty cycle intermittent activities as energy burst-sources.

Exposure of a modern GaAs solar cell with efficiency η and surface area A exposed to light with an insensitivity I harvests a daily energy

$$E ≃ 450 J ( \frac{I}{1000 W \text{/} {m}^{2}} ) ( \frac{η}{20 \%} ) ( \frac{A}{1 {cm}^{2}} ) , \qquad ( 1 )$$

where we have included a reduction of net efficiency by a factor of ½ due to orientation effects, assuming a 12 hr daytime period. A 450 J energy using A=1 cm² by far exceeds the above-mentioned energy requirements for operating low duty-cycle remote sensing applications, including wireless data transmissions in burst-mode. If the surface area is increased to, e.g., A=25 cm² then even indoors the harvest will be about 20 J, providing ample energy for similar monitoring of indoor climate.

Energies on the order of J are easily stored in medium-size capacitors. We may envision using two capacitors, one capacitor C1 dedicated to ultra-lower power measurements and data-logging, and one capacitor C2 dedicated to burst-data transmissions of the accumulated data. While measurements and data-logging can be pursued at minimal power-levels, data-transmission may require considerable power during a brief period of time, allowing a link to be established or re-established. We shall take as a canonical value an energy of about 1 J for such burst-data transmissions. Once a data-link has been established, large amounts of data can be transmitted in a very short time on the order of one second or less. For example, a Bluetooth connection transmits at 112 kbyte/s, which allows days of climate data to be transmitted in one second. In general terms, an optimal burst-transmission is realized on the basis of intermittent links, which are opened in the shortest time possible.

Modern solar cells shown increasing (maximal) efficiencies. For example, GaAs solar cells can now be made with efficiencies well above 20%. These are well-known from their applications to space and the Australian Solar Challenge Competition.

The energy collected by solar cells can be efficiently stored in and retrieved from capacitors using variable DC-DC converters. The storing of energy can be optimized using step-up converters, which produce high-voltage output from a low-voltage input. The retrieval of energy can be optimized using step-down converters, which produce low-voltage output from high-voltage input. Wide-range input DC-DC converters are commercially available products, which can be used for efficient retrieval of the energy stored in the capacitor. However, a dedicated requirement is put on the step-up DC-DC converter, for efficient energy storage.

For maximal efficiency, the step-up DC-DC converter should be a voltage-controlled device with variable output. Charging of a capacitor with voltage V_{c}(t) as a function of time t is done most efficiently, when it is charged slowly such that the rate of energy deposition in the capacitor closely matches the power received from the solar cells. Thus, we consider using a DC-DC step-up converter with time-variable output voltage Vᵤ(t), which leads the capacitor voltage by a small difference

Vᵤ(t)−V_{c}(t)=δᵤ>0 (2)

between the open-terminal voltage output Vᵤ(t) and the capacitor voltage. In this fashion, dissipation in the DC-DC step-up converter is kept minimal, leaving a dissipation

P_{d}=δᵤ²/Z (3)

waisted in heat, where Z denotes the output impedance of the DC-DC converter. Here, δᵤ may vary during harvesting of energy from the solar cells, depending on light intensity. Either the step-up DC-DC converter includes variable or programmable voltage output (e.g. Trescases & Ng 2004), or it provides a current source at its output.

The operation for a battery-free radiation-powered energy-burst source comprises the following steps.
Energy is received from a single or an array of solar cells. The surface area of the solar cells is chosen to produce a daily harvest of energy, to enable measurement and data-logging, as well as data-transmission in burst mode at least once (per day).
Energy from solar cells is efficiently converted to high-voltage using a DC-DC step-up converter and stored in a capacitor. The capacitor will generally be large enough to store up to a few J in energy. The charging process must be regulated for optimal efficiency, that is, the energy storage into the capacitor must closely match the power received from the solar cells.
Energy in the capacitor is efficiently retrieved using a wide-range input DC-DC step-down converter for powering the application, comprising sensor, micro-electronics, and wireless transmission in burst-mode.
When sufficient energy is received in the capacitor, data collected in buffer can be wirelessly transmission to a remote data-processing unit. To this end, a link is established for a single burst of data. This activity is subject to the constraint to preserve sufficient residual energy for a continuation of data-logging over an extended period of time. This applies especially during the night when light may be absent.

### SURVEY OF THE DRAWINGS

FIG. 1. Shown is a block diagram the complete wireless home-climate system, comprising gas-energy observatory (gray shaded region) linked with one or more home-climate monitors, a home-climate control system and a central heating system. Here, the dashed lines represent wireless data-transmission links. The gas-energy observatory consists of a local weather station, a remote display and a gas-meter. Here, the gas-meter houses a CPU, memory for data-archiving, sensor electronics for monitoring the gas-energy consumption through the residential gas-connection, a display and two wireless interfaces. One interface is integrated with the wireless consumer network and the other interface provides a data-link to the gas-supplier. The first mediates residential energy-weather data, whereas the second mediates compatible financial energy data. Both are encrypted for privacy and security.

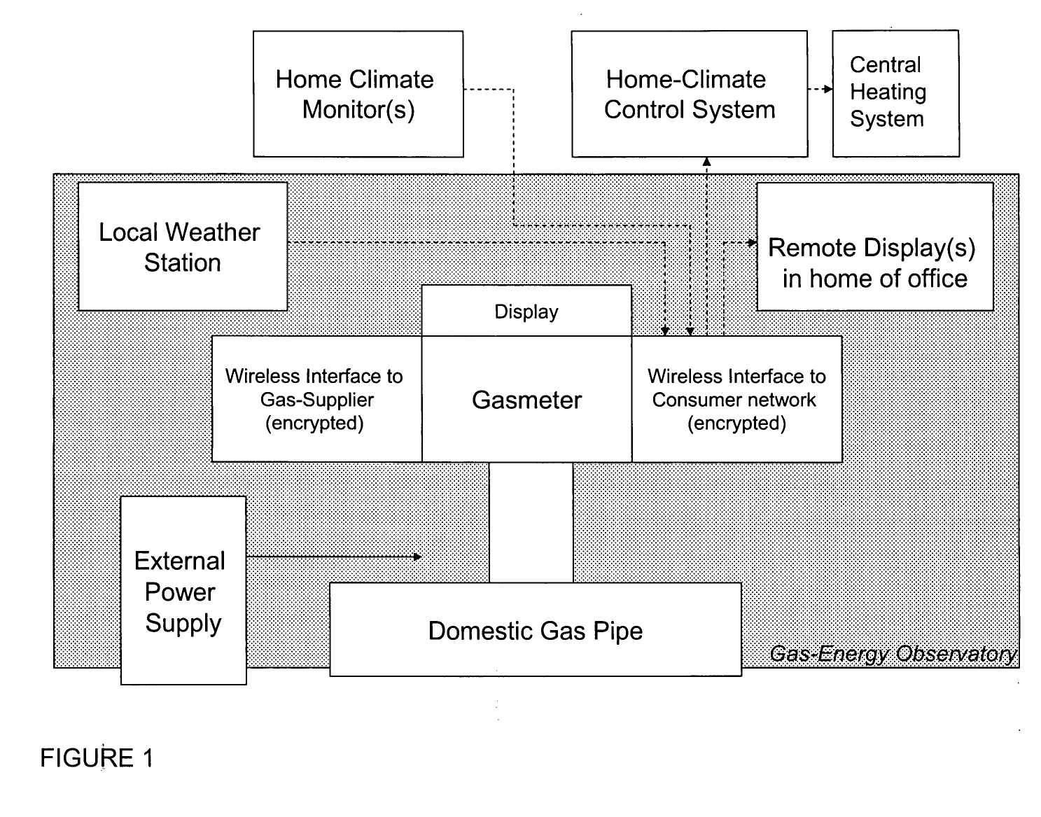

FIG. 2. Shown is a block diagram of the solar radiation powered battery-free energy burst-source serving as a power supply to a wireless weather station. The energy burst-source comprises solar cells for harvesting radiation energy, a step-up DC-DC converter for storage into a capacitor, a step-down DC-DC converter for retrieving energy from the capacitor in terms of a constant voltage power supply to the weather station. The weather station comprises multiple sensors, such as temperature, pressure, humidity and other sensors, a multi-channel analogue-to-digital converter (ADC), a CPU with data-buffer, and low-power display such as an LCD, and a wireless interface for burst data-transmission. Note that the ADC also monitors the voltage, and hence the energy of the capacitor. In this fashion, the CPU is informed, when the capacitor is sufficiently charged to permit burst data-transmission of the data stored in its buffer. Such transmissions are subject to the condition that afterwards, there remains sufficient residual energy in the capacitor to enable continuing monitoring, even during nighttime periods up to Sunrise.

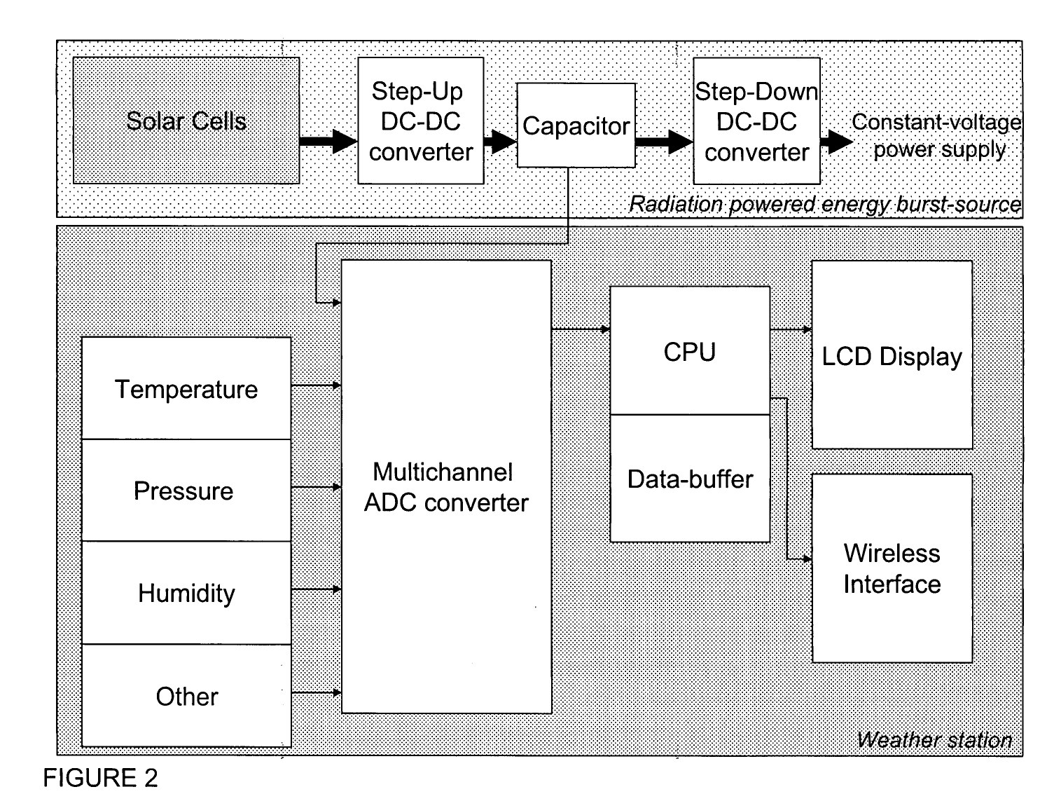

### PREFERRED EMBODIMENTS

The preferred embodiment follows current trends in small, smart and easy-to-use, while paying attention to safety, reliability, data-integrity and battery-free operation to facilitate decade-long observations.

The complete wireless climate-control system is preferrably realized in a wireless local area network which is compatible with mainstream data-transmission protocols, to enable compatibility with commercially available products. In particular, Bluetooth appears to be a viable option, which is increasingly implemented in a wide variety of commercial products such as laptops, PDAs and mobile phones.

In the preferred embodiment, the wireless link has the lowest energy consumption in the idle mode and is time-efficient is establishing or re-awakening a data-link. For this reason, the wireless connection of the solar powered weather station may be realized using a dedicated single-channel wireless link, which requires no overhead during the initiation and closing of a burst data-transmission. In general terms, it is difficult to forecast the optimal choice of wireless link, as the commercially available technologies are rapidly evolving, and new ones are always on the horizon.

The preferred embodiment for the step-up and step-down DC-DC converters are variable converters, which optimize their operations along with the variable capacitor voltage. Charging of the capacitor is optimal when performed slowly, using a voltage-controlled step-up converter, whose output voltage leads the capacitor voltage by a small positive difference. The preferred choice of capacitor aims at having low self-discharge, to permit efficient storage of the energy, especially during time-periods of little or no radiation. Furthermore, high-voltage capacitors may be used, to maximize the energy storage in a small volume.

### SUMMARY

The power of modern information technology in measurement and computation can be used to introduce novel energy saving strategies and algorithms. We recently disclosed a gas-energy observatory which presents the complete picture of real-time residential gas-energy usage in combination with local weather data. These energy-weather data provide direct feedback to the user, and can be used as input to novel energy-saving algorithms for home-climate systems, continuous home energy audits and validation of home-improvements. To facilitate maintenance-free operation of the weather station, we here describe a battery-free, solar powered wireless method of operation for long-term monitoring. Gathering these local weather data over the internet further creates a wide-area climate observation system for climate research and studies on global warming.

We claim:

1. A radiation powered battery-free energy burst-source for powering a remote wireless device with the property that the daily harvest of radiation energy is stored in a capacitor, where the device and its wireless data-transmissions are powered by energy retrieved from said capacitor, where the storage of said energy is made efficient using a step-up DC-DC converter, where the retrieval of said energy is made efficient using a step-down DC-DC converter, where said wireless data-transmission is intermittent in burst-mode to transmit data stored in buffer to a remote host, subject to the constraint that said data-transmission occur while leaving sufficient residual energy stored to maintain sensing capability and local data-logging in a buffer.

2. A solar powered battery-free energy bursts source according to claim 1 with the property that said efficient energy storage to said capacitor is made possible using a voltage-controlled DC-DC step-up converter, where said voltage control maintains a small positive voltage difference between its open-terminal output and said capacitor, where said small positive voltage difference serves to store energy in the capacitor at a rate which most closely matches the power received from the solar cells.

3. A solar powered battery-free energy bursts source according to claim 1 with the property that said efficient energy storage to said capacitor is made possible using a DC-DC step-up converter, whose output is a current source, where the current is regulated to store energy in the capacitor at a rate which most closely matches the power received from the solar cells.

4. A solar powered battery-free energy bursts source according to claim 1 with the property that said weather station uses solar cells of GaAs for optimal efficiency.

5. A solar powered battery-free energy bursts source according to claim 1 with the property that said device uses Bluetooth for the wireless link.

6. A solar powered battery-free energy bursts source according to claim 1 with the property that said device contains a temperature sensor for observing local weather or located inside for monitoring room-climate in homes and buildings.

7. A solar powered battery-free energy bursts source according to claim 5 with the property that said data-transmission is directly into the internet to a remote central data-bank, where the gathering of said data is used to create a wide-area high spatial resolution climate observation system.

8. A solar powered battery-free energy bursts source according to claim 1 with the property that said device controls a heating system as part of a local wireless sensing and control network.

9. A home-climate system comprising a gas-energy meter, a local weather station, a home-climate control system, a heating system and a remote display all connected over a wireless network, where said gas-energy meter and local weather station comprise a gas-energy observatory producing energy-weather data and correlations between gas-energy usage and local weather, where said energy-weather information is transmitted to said home-climate system and to said display, where said home-climate system controls said heating system.

10. A home-climate system according to claim 7 with the property that said display provides the complete picture in high-resolution energy-weather data for visual feedback to the consumer in using residential facilities and heating, where said climate control system provides optimal control for maximal energy-savings and climate comfort allowing for correlations of room-temperature with local weather and the human biological clock.

11. A home-climate system according to claim 7 with the property that said local weather station and home-climate control system are radiation powered and battery free, where said battery-free operation is made possible using an energy-burst source on the basis of efficient energy storage and retrieval in and from a capacitor by the application of modern step-up and step-down DC-DC converters.
